(19) United States
(12) Patent Application Publication
(10) Pub. No.: US 2012/0081297 A1
(43) Pub. Date: Apr. 5, 2012

(54) TOUCH KEYBOARD WITH PHONETIC CHARACTER SHORTCUTS

(75) Inventor: Yuncheol Heo, Gyeonggi-do (KR)

(73) Assignee: Google Inc., Mountain View, CA (US)

(21) Appl. No.: 13/044,276

(22) Filed: Mar. 9, 2011

Related U.S. Application Data
(60) Provisional application No. 61/388,951, filed on Oct. 1, 2010.

(51) Int. Cl. G06F 3/02

(52) U.S. Cl. 345/171

(57) ABSTRACT

In general, this disclosure describes techniques to enable a user of a computing device to select keys representing one or more characters using touch gestures. In one example, a method includes: receiving, on a graphical keyboard of a computing device, touch input including a plurality of selections of one or more keyboard characters currently displayed in the graphical keyboard; determining, by the computing device, a touch input operation that corresponds to the touch input, wherein the touch input operation identifies a character that is not currently displayed on the graphical keyboard, wherein the identified character has a phonetic relationship to the one or more keyboard characters selected by the touch input, and wherein the identified character is different from the one or more keyboard characters selected by the touch input; and generating for display, on an output device of the computing device, the identified character.

This application claims the benefit of U.S. Provisional Application No. 61/388,951, filed Oct. 1, 2010, the entire content of which is incorporated by reference herein.

### TECHNICAL FIELD

This disclosure relates to gesture-based graphical user interfaces and touch-sensitive screens in mobile devices.

### BACKGROUND

A user may interact with applications executing on a computing device (e.g., mobile phone, tablet computer, smart phone, or the like). For instance, a user may install, view, or delete an application on a computing device.

In some instances, a user may interact with a graphical keyboard on a computing device. A user may type on the graphical keyboard by selecting keys. When a user selects a key, a character may be displayed by the computing device. In some instances, when a user selects a key, the computing device may generate input for use in other applications executing on the computing device.

### SUMMARY

In one example, a method includes: receiving, on a graphical keyboard of a computing device, touch input including a plurality of selections of one or more keyboard characters currently displayed on the graphical keyboard; determining, by the computing device, a touch input operation that corresponds to the touch input, wherein the touch input operation identifies a character that is not currently displayed on the graphical keyboard, wherein the identified character has a phonetic relationship to the one or more keyboard characters selected by the touch input, and wherein the identified character is different from the one or more keyboard characters selected by the touch input; and generating for display, on an output device of the computing device, the identified character.

In one example, a computer-readable storage medium is encoded with instructions that cause one or more processors of a computing device to: receive, on a graphical keyboard of a computing device, touch input including a plurality of selections of one or more keyboard characters currently displayed on the graphical keyboard; determine, by the computing device, a touch input operation that corresponds to the touch input, wherein the touch input operation identifies a character that is not currently displayed on the graphical keyboard, wherein the identified character has a phonetic relationship to the one or more keyboard characters selected by the touch input, and wherein the identified character is different from the one or more keyboard characters selected by the touch input; and generate for display, on an output device of the computing device, the identified character.

In one example, a computing device includes: one or more processors; an output device; a keyboard application implemented by the one or more processors to receive a touch input including a plurality of selections of one or more keyboard characters of a graphical keyboard currently displayed on the output device; and means for determining a touch input operation that corresponds to the touch input, wherein the touch input operation identifies a character that is not currently displayed on the graphical keyboard, wherein the identified character has a phonetic relationship to the one or more keyboard characters selected by the touch input, and wherein the identified character is different from the one or more keyboard characters selected by the touch input, wherein the output device is configured to generate for display the identified character.

### BRIEF DESCRIPTION OF DRAWINGS

FIG. 1 is a block diagram illustrating an example of a computing device that may be configured to execute one or more applications and receive a touch input, in accordance with one or more aspects of the present disclosure.

FIG. 2 is a block diagram illustrating further details of one example of computing device shown in FIG. 1, in accordance with one or more aspects of the present disclosure.

FIG. 3 is a flow diagram illustrating an example method that may be performed by a computing device to select a character corresponding to a touch input, where the selected character has a phonetic relationship to one or more characters represented by one or more keys, in accordance with one or more aspects of the present disclosure.

FIG. 4 is a conceptual diagram of a graphical keyboard and two corresponding Korean graphical keyboards, in accordance with one or more aspects of the present disclosure.

FIGS. 5A and 5B illustrate a Korean character set, in accordance with one or more aspects of the present disclosure.

FIG. 6 is a non-limiting example of a user interacting with a computing device having a graphical keyboard, in accordance with one or more aspects of the present disclosure.

FIG. 7 is a non-limiting example of a user interacting with a computing device having a graphical keyboard, in accordance with one or more aspects of the present disclosure.

FIG. 8 is an exemplary table of mappings between keys, touch input operations, and characters, in accordance with one or more aspects of the present disclosure.

### DETAILED DESCRIPTION

Techniques of the present disclosure allow a user of a computing device to provide touch input to select keys and display characters on the computing device. Certain keyboard layouts and input methods have been designed to operate on mobile devices. It may be beneficial to provide a user with a reduced character keyboard and functionality to rapidly select and display characters. A reduced character keyboard provides fewer keys to a user than a standard keyboard but provides larger keys as displayed. Larger keys enable a user to type more quickly and accurately. This benefit may be particularly valuable on mobile devices where a user may wish to engage in rapid communication. Furthermore, some mobile devices may display a keyboard on a touch-sensitive screen. In such embodiments, a user may perform undesired key selections if keys are too small or placed closely together. Larger keys therefore advantageously provide the user with a user-friendly and accurate input device.

A touch input may be used in conjunction with a reduced character keyboard to overcome the disadvantage of fewer keys available to the user. For example, a single tap for a key representing a character may select and display the character. A double tap for the same key may produce a different character. Associating touch inputs with keys on a reduced character keyboard may enable a user to select and display characters accurately and efficiently without limiting the set of characters available to the user. In some examples, characters may be phonetically related and thereby selectable with touch inputs.

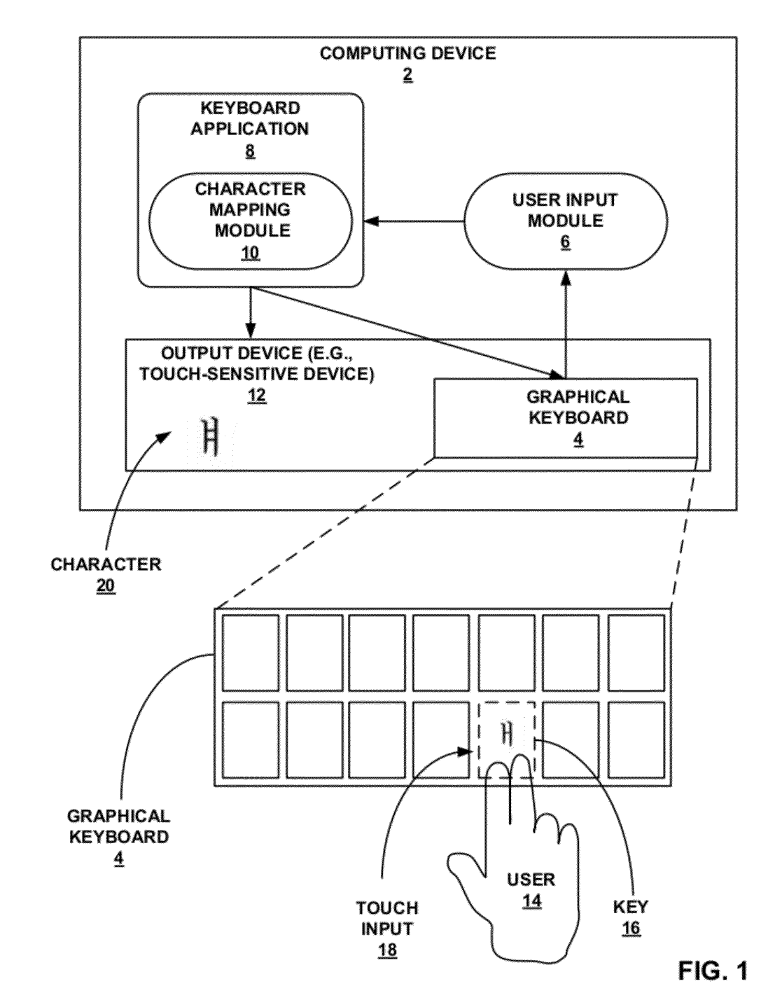

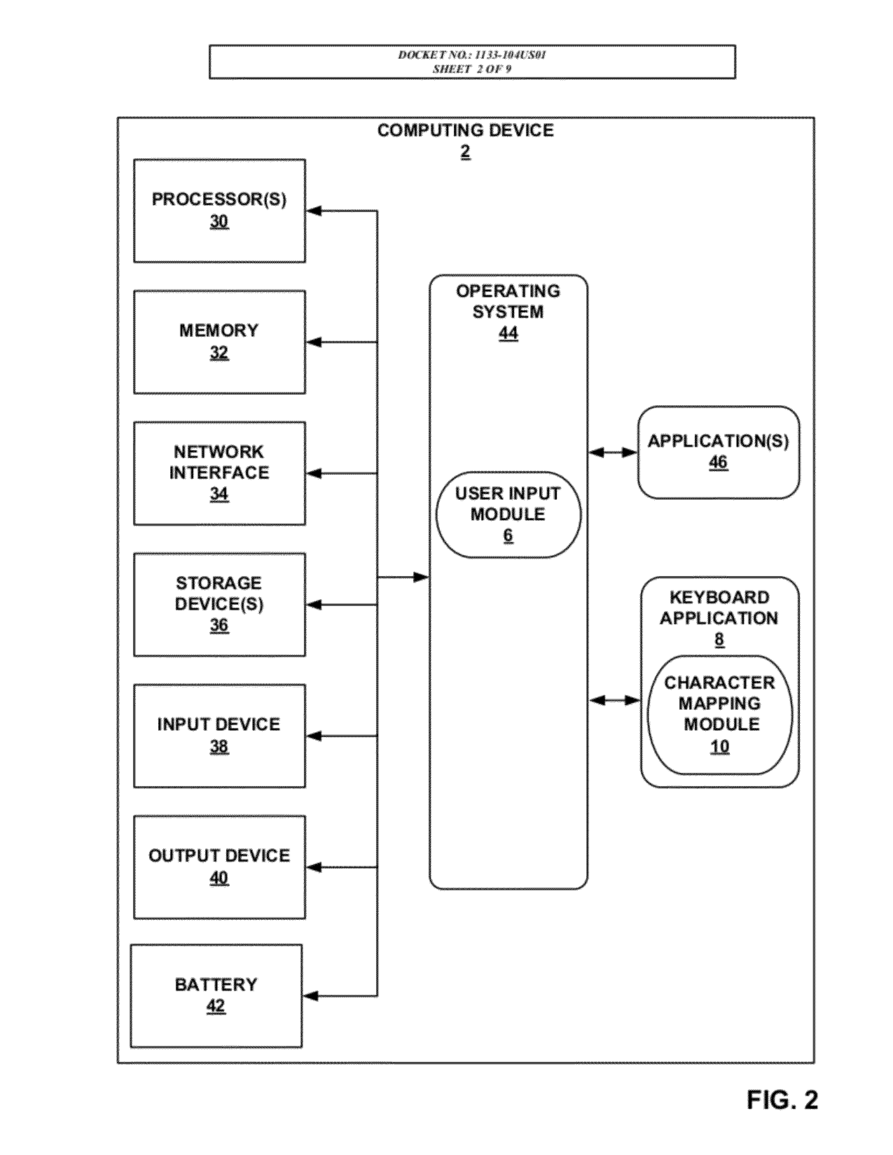

FIG. 1 is a block diagram illustrating an example of a computing device 2 that may be configured to execute one or more applications, e.g. a keyboard application 8, and receive a touch input 18 in accordance with one or more aspects of the present disclosure. Computing device 2 may, in some examples, include or be a part of a portable computing device (e.g. mobile phone, netbook, laptop, tablet device) or a desktop computer. Computing device 2 may also connect to a network including a wired or wireless network. One example of computing device 2 is more fully described in FIG. 2.

In some examples, e.g. FIG. 1, computing device 2 may include an output device 12 such as a touch-sensitive device (e.g., touchscreen), capable of receiving touch input 18 from a user 14. Output device 12 may, in one example, generate one or more signals corresponding to the coordinates of a position touched on output device 12. These signals may then be provided as information to components (e.g., keyboard application 8 in FIG. 1, or processor 30 or operating system 44 in FIG. 2) of computing device 2. Output device 12 may also display information to user 14. For example, output device 12 may display character 20 to user 14. Output device 12 may in other examples display video or other graphical information. Output device 12 may provide numerous forms of output information to user 14, which are further discussed in FIG. 2.

In some examples, output device 12, may display a graphical keyboard 4. Graphical keyboard 4 may display one or more keys, such as key 16. Graphical keyboard 4 may arrange one or more keys in a layout intuitive to user 14. In other examples, graphical keyboard 4 may arrange one or more keys to improve user 14's accuracy and/or speed when selecting one or more keys. Reducing the number of keys of graphical keyboard 4 may be particularly advantageous where computing device 2 is a mobile device and the display area of output device 12 is limited.

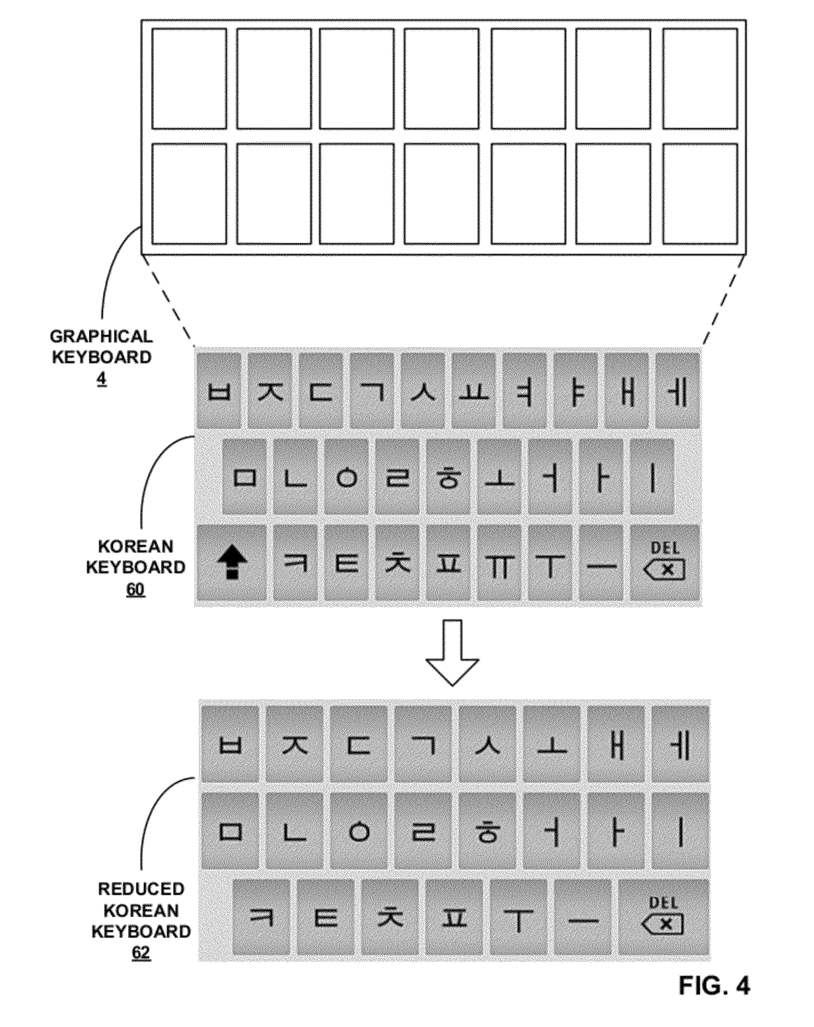

Key 16 may be associated with a character from a natural language. Characters from a natural language may include numbers, letters, symbols, or other indicia capable of communicating meaning either independently or in combination with other characters. For example, key 16 may be associated with or represent the letter “A” in the English language. Key 16 may in another example be associated with or represent the Arabic number “8.” In yet another example, key 16 may be associated with or represent the pound “#” sign. In some examples graphical keyboard 4 may include a key, such as key 16, for each character in a natural language. In other examples, graphical keyboard 4 may include one or more keys corresponding to only a subset of all characters available in a natural language. For example, graphical keyboard 4 may include one or more keys corresponding to only the more frequently used characters in a natural language. In the Korean language, for in one particular example, the least frequently used keys may be ‘ [symbol] ’, ‘ [symbol] ’, ‘ [symbol] ’, ‘ [symbol] ’. By removing these keys and the shift key (shown in FIG. 4, Korean Keyboard 60 as an upward pointing arrow key), each remaining key may, in some examples, may have approximately 25% more surface area.

In other examples, Korean characters ‘ [symbol] ’, ‘ [symbol] ’, ‘ [symbol] ’, ‘ [symbol] ’, or ‘ [symbol] ’, ‘ [symbol] ’ may be removed from the keyboard. By removing some or all of these characters, more surface area can be provided for each key. Korean characters, ‘ [symbol] ’, ‘ [symbol] ’, ‘ [symbol] ’, ‘ [symbol] ’, may be alternatively input by combining ‘ [symbol] ’, ‘ [symbol] ’, ‘ [symbol] ’, ‘ [symbol] ’ with ‘ [symbol] ’ using touch inputs. In other examples ‘ [symbol] ’ and ‘ [symbol] ’ may be removed and alternatively input by combining ‘ [symbol] ’, ‘ [symbol] ’ with ‘|’ using touch inputs, as will be described in greater detail below.

User 14 may interact with output device 12, e.g. a touch-sensitive screen, by performing touch input 18 on output device 12. For example, computing device 2 may display graphical keyboard 4 on output device 12. User 14 may select one or more keys 16 using a touch input 18. Output device 12 may generate a signal corresponding to touch input 18 that is transmitted to user input module 6. User input module 6 may process touch input 18 received from user 14. In some cases, user input module 6 may perform additional processing on touch input 18, e.g., converting touch input 18 into more usable forms. In other cases, user input module 6 may transmit a signal corresponding to touch input 18 to an application, e.g. keyboard application 8, or other component in computing device 2.

Touch input 18 may include one or more gestures performed by user 14. User 14 may perform touch input18 by placing one or more fingers in contact with, e.g., output device 12, which may be a touch-sensitive screen. In one example, user 14 may move one or more fingers while in contact with touch-sensitive screen 4. In another example, touch input 18 may include user 14 touching and releasing one or more keys 16 on graphical keyboard 4. Touch input 18 may include any well-known gestures, e.g., pinch, de-pinch, tap, rotate, double tap, long press, or combo press.

For example, user 14 may double-tap key 16, i.e., press key 16 in short succession. In another example, user 14 may long press key 16, i.e., press key 16 and hold it for an extended period rather than immediately releasing key 16. In yet another example, user 14 may perform a combo press on graphical keyboard 4, e.g., simultaneously pressing key 16 and at least one other key on graphical keyboard 4. In some examples, computing device 2 may determine the duration of touch input 18. For example, computing device 2 may measure the period of time that a key is pressed to distinguish between, e.g., a single tap and a long press.

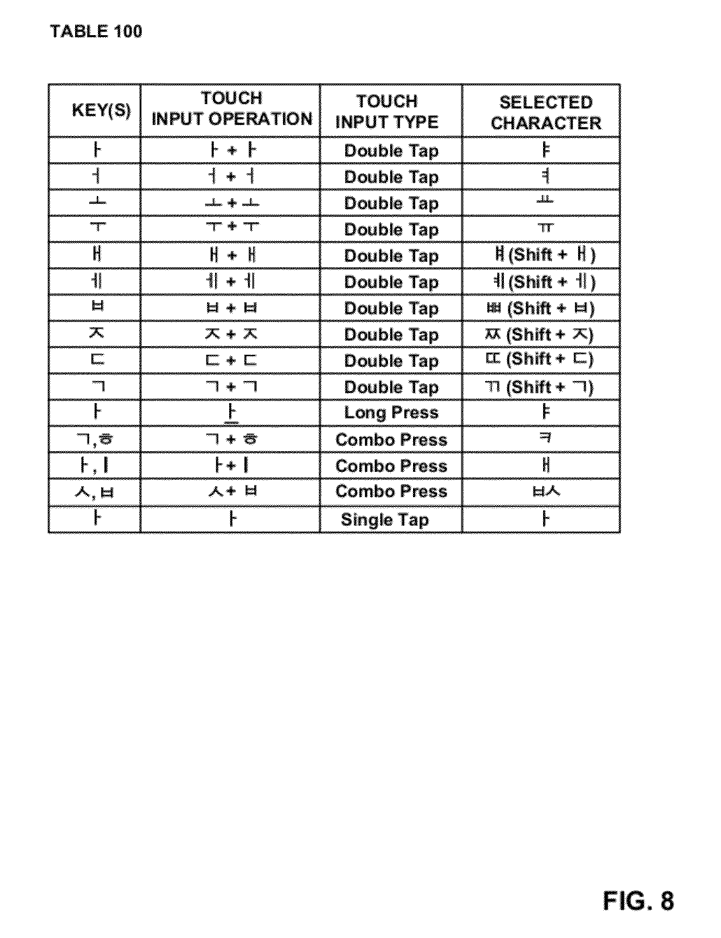

User input module 6 may receive a signal corresponding to touch input 18 and transmit the signal to keyboard application 8. In some examples, keyboard application 8 may include a character mapping module 10. Character mapping module 10 may perform a touch operation on the signal corresponding to touch input 18. The touch operation may select a character, e.g. character 20, corresponding to touch input 18. In some examples, character mapping module 10 may perform a lookup of selected character 20 in a table or database (not shown) based on the touch input operation, where the table contains mappings between characters and one or more touch input operations. For example, FIG. 8, illustrates an exemplary table 100 of mappings between keys, touch input operations, and characters.

In one example, character mapping module 10 may perform a lookup by matching the character associated with the user-selected key and a key in table 100. Character mapping module 10 may then perform a lookup of the touch input operation associated with the key. Using the key and touch input, character mapping module 10 may identify the corresponding selected character. Table 100 may include a touch input type corresponding to the input touch. For example, tapping a key twice in short succession may include a double tap. In some examples, the touch input operation may select character 20 based on the touch input operation corresponding to touch input 18, and display character 20 to output device 12.

A touch input operation performed by character mapping module 10 may select character 20 based on a phonetic relationship. For example, a phonetic relationship may exist between character 20 and one or more characters corresponding to one or more keys, such as key 16, selected by touch input 18. In one example a phonetic relationship may be illustrated by the relationship between a vowel and a diphthong. A diphthong may include two or more adjacent vowel sounds within the same syllable. A vowel and a diphthong may be phonetically related when the diphthong includes the vowel sound as one of the two or more adjacent vowel sounds. For example, in the English language, the word “loin” may be a diphthong because the vowel sounds “o” and “e” are adjacent in the same syllable. In the Korean language, for example, the diphthong ‘ [symbol] ’ (expressed as “yae”) may include the vowel ‘ [symbol] ’ (expressed as “ae”) as an adjacent vowel. In one example, diphthong character ‘ [symbol] ’ and vowel character ‘ [symbol] ’ may each be separate keys of graphical keyboard 4. In other examples, only vowel ‘ [symbol] ’ may be included as a key 16 on graphical keyboard 4. Thus, more generally, a phonetic relationship may exist where a phonetic characteristic is shared between two characters. In other examples, a phonetic relationship may be a syntactic relationship between two or more characters in the linguistic structure of a natural language.

In some examples, the identified character, e.g., character 20 is not currently displayed on the keyboard. In this way, the size of each key 16 may be increased. For example, character 20 may not be displayed on graphical keyboard 4 but may be identified for display when user 14 selects key 16 using a touch input. In other examples, the identified character, e.g., character 20 may be different from the one or more keyboard characters selected by the touch input. For example, in FIG. 1, character 20, i.e., ‘ [symbol] ’ is different from the character of key 16, i.e., ‘ [symbol] ’ In other words, the identified character may be different from the one or more keyboard characters selected by the touch input. In another example, a character “B” may be different from the character “b.”

In one non-limiting example, vowel ‘ [symbol] ’ may be included as key 16 on graphical keyboard 4 but diphthong ‘ [symbol] ’ may not. If user 14 wishes to select or display ‘ [symbol] ’, user 14 may perform a touch input 18, e.g., double-tap ‘ [symbol] ’ key 16. User input module 6 may receive the double-tap signal corresponding to touch input 18 and transmit a corresponding signal to character mapping module 10 of keyboard application 8. Character mapping module 10 may select diphthong character ‘ [symbol] ’ 20 according to its phonetic relationship with vowel ‘ [symbol] ’. Computing device 2 may in some examples display selected character ‘ [symbol] ’ 20 to output device 12.

In another exemplary embodiment, a phonetic relationship may be the relationship between a single vowel and a double vowel in the Korean language. For example, the Korean single vowel ‘ [symbol] ’ (expressed as ‘a’) may be phonetically related to the Korean double vowel ‘ [symbol] ’ (expressed as “ya”). In another example, a phonetic relationship may be the relationship between a simple consonant and an aspirated derivative of the simple consonant. An aspirated derivative may be formed by combining the unaspirated letters with an extra stroke. Unaspirated letters may include ‘ [symbol] ’, ‘ [symbol] ’, ‘ [symbol] ’, and ‘ [symbol] ’. For example, the Korean simple consonant ‘ [symbol] ’ (expressed as “giyeok”) may be phonetically related to the Korean aspirated derivative of the simple consonant ‘ [symbol] ’ (expressed as “kieuk”), e.g., by combining ‘ [symbol] ’ with ‘ [symbol] ’ (expressed as “hieut”). In yet another example, a phonetic relationship may be the relationship between a simple consonant and a faucalized consonant. A faucalized consonant may refer more generally to a “double letter” or “double consonant” in the Korean language. A faucalized consonant may be created by doubling a simple consonant letter.

For example, the Korean simple consonant ‘ [symbol] ’ (expressed as “giyeok”) may be phonetically related to the Korean faucalized consonant ‘ [symbol] ’ (expressed as “ssang-giyeok”). In another example, a phonetic relationship may be the relationship between a simple consonant and a consonant cluster. A consonant cluster may be created by combining two different consonant letters. For example, the simple consonant ‘ [symbol] ’ (expressed as “siot”) may be phonetically related to the consonant cluster ‘ [symbol] ’ (expressed as “bieup-siot”). In another example, the phonetic relationship may be the relationship between a first double vowel and a second double vowel. For example, the double vowel ‘ [symbol] ’ (expressed as “ae”) may be phonetically related to the double vowel ‘ [symbol] ’ (expressed as “yae”).

Various aspects of the disclosure may provide, in certain instances, one or more benefits and advantages. For example, a typical Korean mobile phone keyboard has twelve keys and the Korean alphabet has 40 characters. On average, a typical Korean mobile phone may require two or three key presses to enter each character, which can take substantial time. By removing keys from the graphical keyboard as in the present disclosure, e.g., diphthong keys, and providing an alternative way of entering characters, a computing device can provide a larger key size and thereby reduce the error rate of typing without degrading typing speed. Another possible benefit of the disclosure is that phonetic relationships may be intuitive to the user and therefore easier to learn. A user may, therefore, become familiar with the graphical keyboard more quickly. For example, a graphical keyboard with some keys removed may be similar to a typical Korean key layout.

Yet another possible benefit of removing keys and using phonetic relationships is that a single touch input may be sufficient to select and display a character from the graphical keyboard. By making more characters available through phonetic relationships, fewer keystrokes are required to display desired characters. The aforementioned benefits and advantages are exemplary and other such benefits and advantages may be apparent in the previously-described non-limiting examples. While some aspects of the present disclosure may provide all of the aforementioned exemplary benefits and advantages, no aspect of the present disclosure should be construed to necessarily require any or all of the aforementioned exemplary benefits and advantages.

FIG. 2 is a block diagram illustrating further details of one example of computing device 2 shown in FIG. 1. FIG. 2 illustrates only one particular example of computing device 2, and many other example embodiments of computing device 2 may be used in other instances.

As shown in the specific example of FIG. 2, computing device 2 includes one or more processors 30, memory 32, a network interface 34, one or more storage devices 36, input device 38, output device 40, and battery 42. Computing device 2 also includes an operating system 44, which may include user input module 6 executable by computing device 2. Computing device 2 may include one or more applications 46 and keyboard application 8, which may include character mapping module 10 executable by computing device 2. Operating system 44, application 46 and keyboard application 8 are also executable by computing device 2. Each of components 30, 32, 34, 36, 38, 40, 42, 44, 46, 6, 8, and 10 may be interconnected (physically, communicatively, and/or operatively) for inter-component communications.

Processors 30 may be configured to implement functionality and/or process instructions for execution in computing device 2. Processors 30 may be capable of processing instructions stored in memory 32 or instructions stored on storage devices 36.

Memory 32 may be configured to store information within computing device 2 during operation. Memory 32 may, in some examples, be described as a computer-readable storage medium. In some examples, memory 32 is a temporary memory, meaning that a primary purpose of memory 32 is not long-term storage. Memory 32 may also, in some examples, be described as a volatile memory, meaning that memory 32 does not maintain stored contents when the computer is turned off. Examples of volatile memories include random access memories (RAM), dynamic random access memories (DRAM), static random access memories (SRAM), and other forms of volatile memories known in the art. In some examples, memory 32 may be used to store program instructions for execution by processors 30. Memory 32 may be used by software or applications running on computing device 2 (e.g., one or more of applications 46) to temporarily store information during program execution.

Storage devices 36 may also include one or more computer-readable storage media. Storage devices 36 may be configured to store larger amounts of information than memory 32. Storage devices 36 may further be configured for long-term storage of information. In some examples, storage devices 36 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Computing device 2 also includes a network interface 34. Computing device 2 may utilize network interface 34 to communicate with external devices via one or more networks, such as one or more wireless networks. Network interface 34 may be a network interface card, such as an Ethernet card, an optical transceiver, a radio frequency transceiver, or any other type of device that can send and receive information. Examples of such network interfaces may include Bluetooth®, 3G and WiFi® radios in mobile computing devices as well as USB. Examples of such wireless networks may include WiFi®, Bluetooth®, and 3G. In some examples, computing device 2 may utilize network interface 34 to wirelessly communicate with an external device (not shown) such as a server, mobile phone, or other networked computing device.

Computing device 2 may also include one or more input devices 38. Input device 38 may be configured to receive input from a user through tactile, audio, or video feedback. Examples of input device 38 may include a touch-sensitive screen, mouse, a keyboard, e.g., graphical keyboard 4, a voice responsive system, video camera, or any other type of device for detecting a command from a user.

One or more output devices 40 may also be included in computing device 2, e.g., output device 12. Output device 40 may be configured to provide output to a user using tactile, audio, or video stimuli. Output device 40 may include a touch-sensitive screen, sound card, a video graphics adapter card, or any other type of device for converting a signal into an appropriate form understandable to humans or machines. Additional examples of output device 40 may include a speaker, a cathode ray tube (CRT) monitor, a liquid crystal display (LCD), or any other type of device that can generate intelligible output to a user.

Computing device 2 may include one or more batteries 42, which may be rechargeable and provide power to computing device 2. Battery 42 may be made from nickel-cadmium, lithium-ion, or other suitable material.

Computing device 2 may include operating system 44. Operating system 44 may control the operation of components of computing device 2. For example, operating system 44 may facilitate the interaction of application 46 or keyboard application 8 with processors 30, memory 32, network interface 34, storage device 36, input device 38, output device 40, and battery 42. Examples of operating system 44 may include Android®, Apple iOS®, Blackberry® OS, Symbian OS®, Linux®, and Microsoft Windows Phone 7®.

Operating system 44 may additionally include user input module 6. User input module 6 may be executed as part of operating system 44. In other cases, user input module 6 may be implemented or executed by computing device 2. User input module 6 may process input, e.g., touch input 18 received from user 22 through input device 38 or output device 40. Alternatively, user input module 6 may receive input from a component such as processors 30, memory 32, network interface 34, storage devices 36, output device 40, battery 42, or operating system 44. In some cases, user input module 6 may perform additional processing on touch input 18. In other cases, user input module 6 may transmit input to an application, e.g. application 46 or keyboard application 8, or other component in computing device 2.

Any applications, e.g. application 46 or keyboard application 8, implemented within or executed by computing device 2 may be implemented or contained within, operable by, executed by, and/or be operatively/communicatively coupled to components of computing device 2, e.g., processors 30, memory 32, network interface 34, and/or storage devices 36.

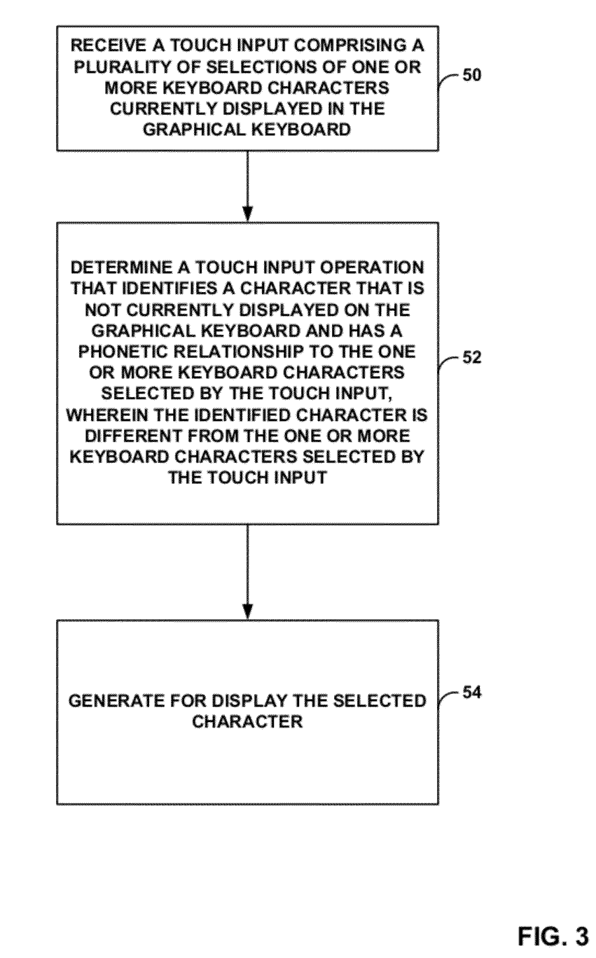

FIG. 3 is a flow diagram illustrating an example method that may be performed by a computing device to select a character corresponding to a touch input, where the selected character has a phonetic relationship to a plurality of selections of one or more keys. For example, the method illustrated in FIG. 3 may be performed by computing device 2 shown in FIGS. 1 and/or 2.

The method of FIG. 3 includes, receiving, on a graphical keyboard of a computing device, touch input including a plurality of selections of one or more keyboard characters currently displayed on the graphical keyboard (50). The method further includes determining, by the computing device, a touch input operation that corresponds to the touch input, wherein the touch input operation identifies a character that is not currently displayed on the graphical keyboard, wherein the identified character has a phonetic relationship to the one or more keyboard characters selected by the touch input, and wherein the identified character is different from the one or more keyboard characters selected by the touch input (52). The method further includes generating for display, on an output device of the computing device, the identified character (54).

In some examples, the method of FIG. 3 includes receiving, on the graphical keyboard, the touch input including a single selection of one keyboard character currently displayed in the graphical keyboard; and selecting, by the computing device for purposes of display, the one keyboard character currently displayed in the graphical keyboard. In some examples, the method includes receiving, on the graphical keyboard, the touch input including a single selection of one keyboard character currently displayed in the graphical keyboard; and selecting, by the computing device for purposes of display, the one keyboard character currently displayed in the graphical keyboard. In some examples, the method includes determining, by the computing device, the touch input operation that corresponds to the touch input includes determining, by the computing device, a lookup of the identified character in a table based on the touch input operation, wherein the table includes mappings between one or more characters and one or more touch input operations.

In some examples, the method includes storing the table in a database on the computing device. In some examples of the method, receiving, on the graphical keyboard of the computing device, the touch input includes determining, by the computing device, a duration of at least one of the selections of the touch input. In some examples of the method, determining, by the computing device, the duration of the at least one of the selections of the touch input further includes selecting the input operation based on the duration of the at least one of the selections of the touch input. In some examples, the identified character is not represented in the graphical keyboard.

In some examples, the phonetic relationship includes a relationship between a vowel and a diphthong. In some examples, the phonetic relationship includes a relationship between a single vowel and a double vowel. In one example, the phonetic relationship includes a relationship between a simple consonant and an aspirated derivative of the simple consonant. In some examples, the phonetic relationship includes a relationship between a simple consonant and a faucalized consonant. In some examples, the phonetic relationship includes a relationship between a simple consonant and a consonant cluster.

In some examples, the phonetic relationship includes a relationship between a first double vowel and a second double vowel. In some examples, the graphical keyboard is displayed by a touch-sensitive screen of the computing device. In some examples, the touch input includes a swipe, pinch, de-pinch, tap, rotate, double tap, long press, or combo press. In one example, each of the one or more keyboard characters are selected for representation on the graphical keyboard based on a frequency, wherein the frequency includes a number of occurrences that a keyboard character of the graphical keyboard is selected by a user. In some examples, the one or more keyboard characters of the graphical keyboard include a frequently selected group of characters that are more frequently selected by a user than a less frequently selected group of characters. In some examples, the one or more keyboard characters of the graphical keyboard are not phonetically related.

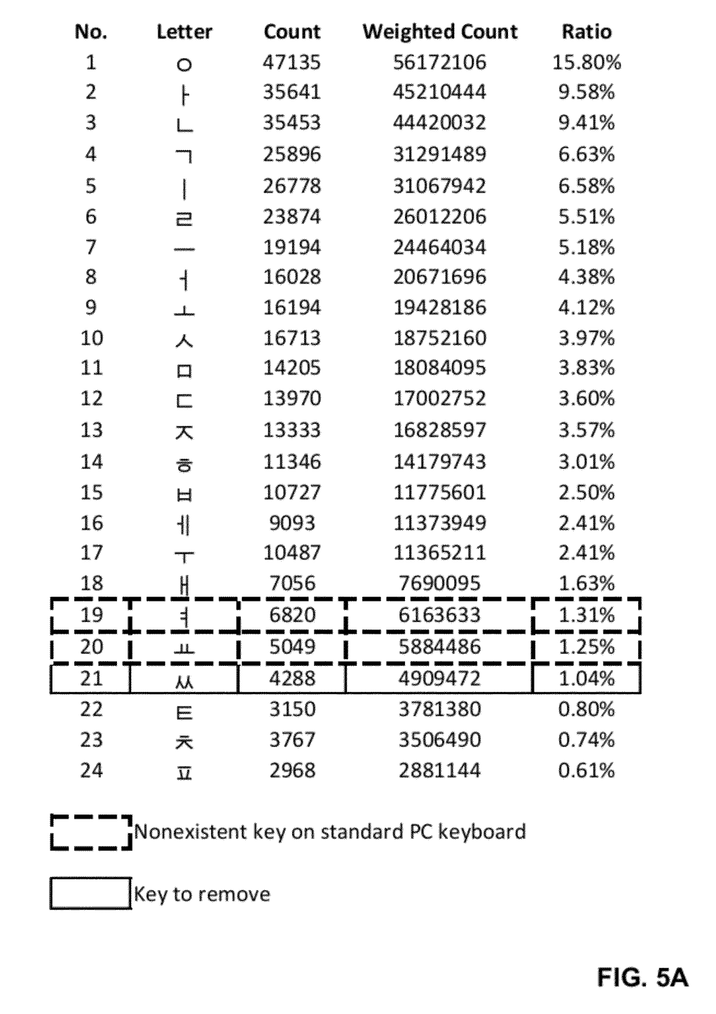

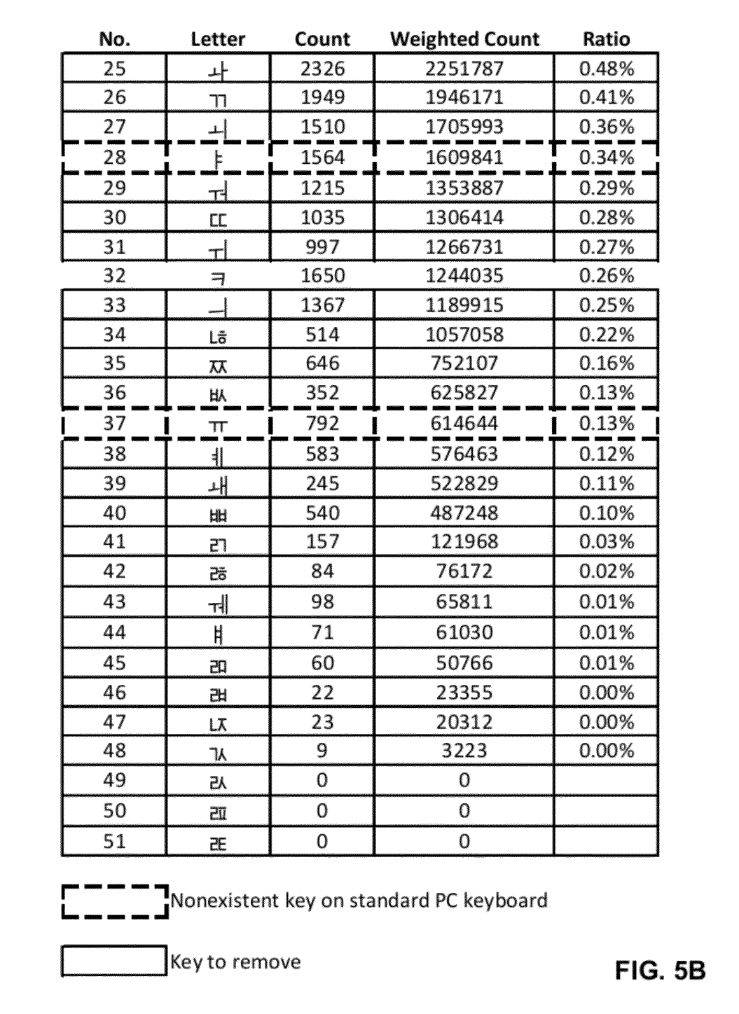

FIG. 4 is a conceptual diagram of a graphical keyboard 4 and two corresponding Korean graphical keyboards. Graphical keyboard 4 may be a graphical keyboard as described in FIGS. 1 and 2. Graphical keyboard 4 may include 28 keys as shown in Korean keyboard 60. In some examples, it may be advantageous to eliminate some keys on a graphical keyboard. For example, a user may type more quickly and accurately if keys are larger, particularly on a mobile device. In the Korean language, for example, the least frequently used keys may be, in some cases, ‘ [symbol] ’, ‘ [symbol] ’, ‘ [symbol] ’, ‘ [symbol] ’. By removing these keys and the shift key (shown in FIG. 4, Korean Keyboard 60 as an upward pointing arrow key), each remaining key may, in some examples, have approximately 25% more surface area. FIG. 4 illustrates reduced Korean keyboard 62 with some keys removed from Korean keyboard 60. In some examples, e.g. FIG. 4, keys corresponding to characters that are least frequently used may be eliminated from Korean keyboard 60 to create reduced Korean keyboard 62 (see e.g., FIG. 5 “Keys to remove”). In other examples, keys corresponding to characters that have phonetic relationships to other characters on the graphical keyboard may be eliminated. For example, the double-vowel ‘ [symbol] ’ may be eliminated from Korean keyboard 60 because it is phonetically related to vowel ‘ [symbol] ’ as shown in reduced Korean keyboard 62.

FIGS. 5A and 5B illustrate, for example, a full Korean character set. FIG. 5 further illustrates character keys that may be removed from a keyboard as well as keys that may not exist on a standard personal computer (PC) keyboard. The Count, Weighted Count, and Ratio columns provide statistical data on the frequency with which each letter, i.e., a character, is selected, according to one non-limiting example. For example, in a total sampling of character selections of the particular example, the character ‘ [symbol] ’ may be selected 35,641 times. For example, the character ‘ [symbol] ’ may be selected 35,641 times. In another example, Count may refer to a number of occurrences of a letter in a dictionary. For example, the character ‘ [symbol] ’ may occur 35,641 times in a dictionary.

In some examples, statistical weighting may be used to scale the 35,641 selections or instances to 45,210,444. For example, a Weighted Count of 45,210,444 may be the sum of multiplying the Count of a character and the frequency of the character in each word of a dictionary. In one example, as a percentage of total selections, the character ‘ [symbol] ’ is selected 9.58% of the time as shown in the Ratio column. In another example, 9.58% refers to the ratio of the Weighted Count of character ‘ [symbol] ’ and the sum of all Weighted Counts for each character. Using a Ratio, the character ‘ [symbol] ’ is determined to be frequently selected by a user and/or appears frequently in a dictionary, and therefore it is not removed from the keyboard. In contrast, the character ‘ [symbol] ’ is selected only 0.01% of the time in a sampling. Therefore, ‘ [symbol] ’ may, in some examples be removed from the keyboard. Characters removed from the keyboard may be based on use testing data of numerous, different users, dictionaries or other similar statistical techniques. FIGS. 5A and 5B are non-limiting examples of such data for purposes of illustration only.

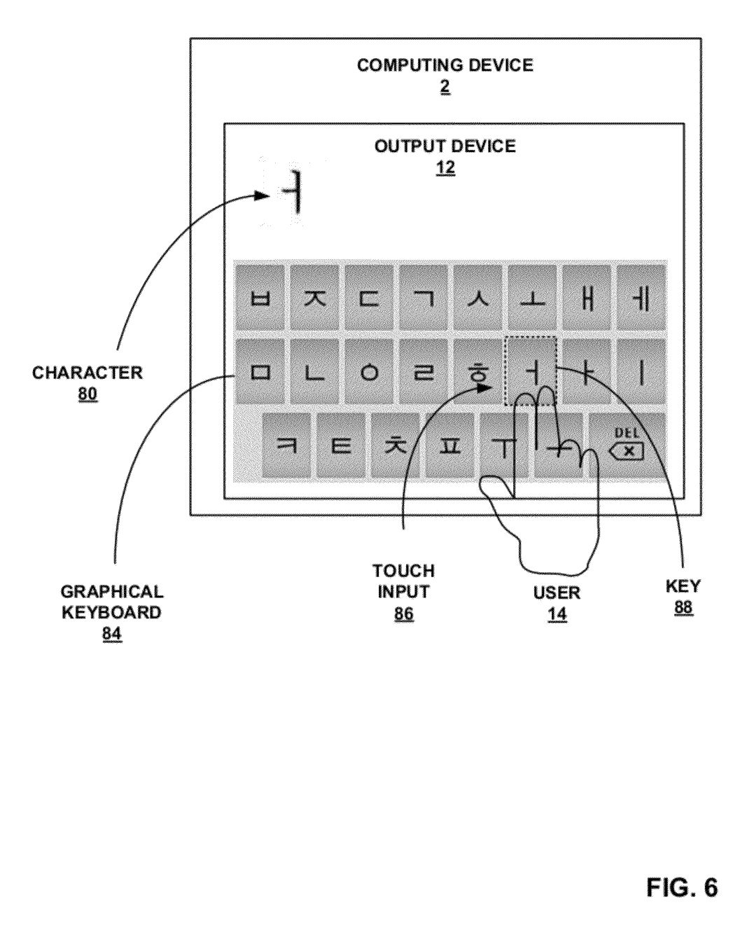

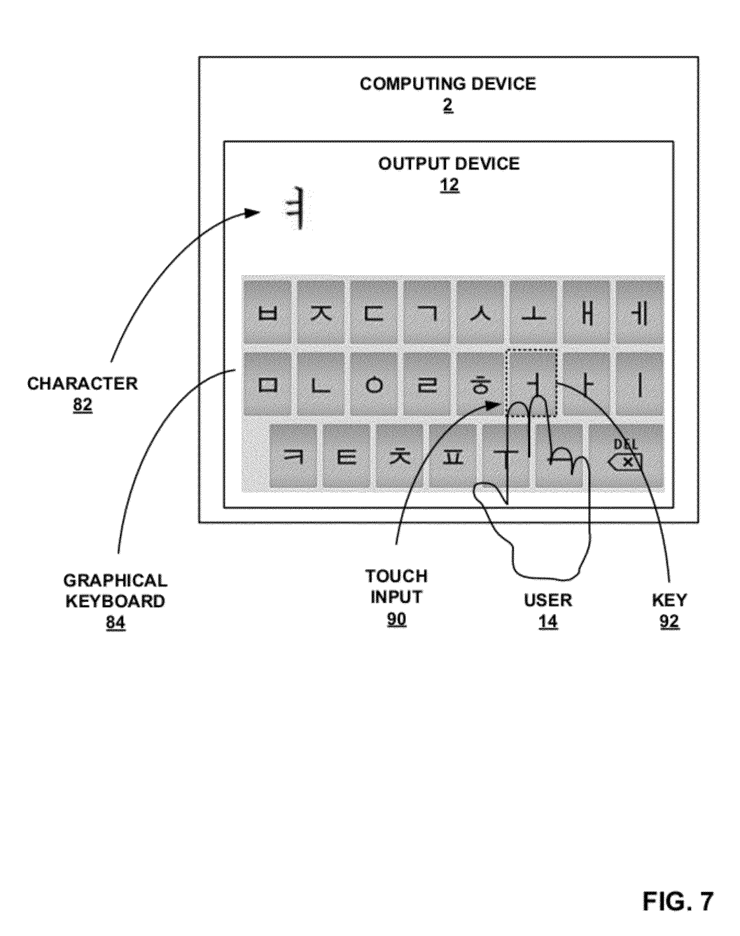

FIGS. 6 and 7 illustrate two non-limiting examples of a user interacting with a computing device having a graphical keyboard. FIG. 6 illustrates user 14 selecting a key 88 corresponding to character ‘ [symbol] ’ using touch input 86. Touch input 86 may be a single tap.

Computing device 2, in response to receiving touch input 86 from graphical keyboard 84, may select and display character ‘ [symbol] ’ 80 on output device 12, e.g., a touch-sensitive display. FIG. 7 illustrates user 14 selecting a key 92 corresponding to character ‘ [symbol] ’ using touch input 90. Touch input 90 may be a double tap. Computing device 2, in response to receiving touch input 90 from graphical keyboard 84, may perform a touch operation of a keyboard application (not shown). The touch input operation may select a ‘ [symbol] ’ character corresponding to touch input 90 because ‘ [symbol] ’ and ‘ [symbol] ’ have a phonetic relationship. The touch operation may perform a lookup in, e.g., table 100 (see FIG. 8), to select the corresponding character. Computing device 2 may display character 82 on output device 12, e.g., a touch-sensitive display.

FIG. 8 is an exemplary table of mappings between keys, touch input operations, and characters, in accordance with one or more aspects of the present disclosure. More generally, table 100 may include mappings of Keys, Touch Input Operations, Touch Input Types, and Selected Characters. The mappings may be used by a touch input operation to determine, when a key is pressed on a graphical keyboard, which character is selected and displayed by a computing device. For example, a Key may include a key on a graphical keyboard, which may correspond to a character, e.g., a ‘ [symbol] ’ character. When a user performs a Touch Input, e.g., a Double Tap, a touch input operation performed by a computing device may select character ‘ [symbol] ’ and display it to an output device of a computing device. Table 100 may in some examples be stored in a database on a computing device. Table 100 may include mappings between a key and any touch input operation, e.g., a swipe, pinch, de-pinch, tap, rotate, double tap, long press, or combo press.

In some examples, a computing device may determine the duration of one of more components, or selections, included in a touch input. For example, the computing device may measure a period of time that a key is pressed to distinguish between, e.g., a single tap and a long press. A single tap may correspond to a touch input lasting a specified period of time, e.g., approximately 0.25-0.5 seconds. A long press may be distinguished from a single tap because the long press corresponds to a touch input lasting, e.g., approximately greater than 0.5 seconds. A double tap may include a touch input corresponding to two 0.25-0.5 second touch inputs occurring in a specified period of time, e.g., approximately within second. In each example, the computing device identifies a relationship between the duration of the touch input and the corresponding input operation (e.g., touch input operation for touch input) by measuring the amount of time for a touch input (e.g., time that a key is pressed), or the amount of time between touch inputs (e.g., time between key presses). These techniques may be extended more generally by the computing device to identify any touch input.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable medium encoded with instructions. Instructions embedded or encoded in an article of manufacture including a computer-readable medium encoded, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage media may include non-transitory media. The term “non-transitory” may indicate that the storage medium is not embodied in a carrier wave or a propagated signal. In certain examples, a non-transitory storage medium may store data that can, over time, change (e.g., in RAM or cache).

Various aspects of the disclosure have been described. These and other embodiments are within the scope of the following claims.

1. A method comprising:
receiving, on a graphical keyboard of a computing device, touch input comprising a plurality of selections of one or more keyboard characters currently displayed on the graphical keyboard;
determining, by the computing device, a touch input operation that corresponds to the touch input, wherein the touch input operation identifies a character that is not currently displayed on the graphical keyboard, wherein the identified character has a phonetic relationship to the one or more keyboard characters selected by the touch input, and wherein the identified character is different from the one or more keyboard characters selected by the touch input; and
generating for display, on an output device of the computing device, the identified character.

2. The method of claim 1, further comprising:
receiving, on the graphical keyboard, the touch input comprising a single selection of one keyboard character currently displayed on the graphical keyboard; and
selecting, by the computing device for purposes of display, the one keyboard character currently displayed in the graphical keyboard.

3. The method of claim 1, wherein determining, by the computing device, the touch input operation that corresponds to the touch input comprises determining, by the computing device, a lookup of the identified character in a table based on the touch input operation, wherein the table comprises mappings between one or more characters and one or more touch input operations.

4. The method of claim 3, further comprising:
storing the table in a database on the computing device.

5. The method of claim 1, wherein receiving, on the graphical keyboard of the computing device, the touch input comprises determining, by the computing device, a duration of at least one of the selections of the touch input.

6. The method of claim 5, wherein determining, by the computing device, the duration of the at least one of the selections of the touch input further comprises selecting the input operation based on the duration of the at least one of the selections of the touch input.

7. The method of claim 1, wherein the identified character is not represented in the graphical keyboard.

8. The method of claim 1, wherein the phonetic relationship comprises a relationship between a vowel and a diphthong.

9. The method of claim 1, wherein the phonetic relationship comprises a relationship between a single vowel and a double vowel.

10. The method of claim 1, wherein the phonetic relationship comprises a relationship between a simple consonant and an aspirated derivative of the simple consonant.

11. The method of claim 1, wherein the phonetic relationship comprises a relationship between a simple consonant and a faucalized consonant.

12. The method of claim 1, wherein the phonetic relationship comprises a relationship between a simple consonant and a consonant cluster.

13. The method of claim 1, wherein the phonetic relationship comprises a relationship between a first double vowel and a second double vowel.

14. The method of claim 1, wherein the graphical keyboard is displayed by a touch-sensitive screen of the computing device.

15. The method of claim 1, wherein the touch input comprises a swipe, pinch, de-pinch, tap, rotate, double tap, long press, or combo press.

16. The method of claim 1, wherein each of the one or more keyboard characters are selected for representation on the graphical keyboard based on a frequency, wherein the frequency comprises a number of occurrences that a keyboard character of the graphical keyboard is selected by a user.

17. The method of claim 16, wherein the one or more keyboard characters of the graphical keyboard comprise a frequently selected group of characters that are more frequently selected by a user than a less frequently selected group of characters.

18. The method of claim 1, wherein the one or more keyboard characters of the graphical keyboard are not phonetically related.

19. A computer-readable storage medium encoded with instructions that cause one or more processors of a computing device to:
receive, on a graphical keyboard of a computing device, touch input comprising a plurality of selections of one or more keyboard characters currently displayed on the graphical keyboard;
determine, by the computing device, a touch input operation that corresponds to the touch input, wherein the touch input operation identifies a character that is not currently displayed on the graphical keyboard, wherein the identified character has a phonetic relationship to the one or more keyboard characters selected by the touch input, and wherein the identified character is different from the one or more keyboard characters selected by the touch input; and
generate for display, on an output device of the computing device, the identified character.

20. A computing device, comprising:
one or more processors;
an output device;
a keyboard application implemented by the one or more processors to receive a touch input comprising a plurality of selections of one or more keyboard characters of a graphical keyboard currently displayed on the output device; and
means for determining a touch input operation that corresponds to the touch input, wherein the touch input operation identifies a character that is not currently displayed on the graphical keyboard, wherein the identified character has a phonetic relationship to the one or more keyboard characters selected by the touch input, and wherein the identified character is different from the one or more keyboard characters selected by the touch input,
wherein the output device is configured to generate for display the identified character.
